(19) United States
(12) Patent Application Publication
(10) Pub. No.: US 2011/0051560 A1
(43) Pub. Date: Mar. 3, 2011

(54) Remote automatic setting of clock radio

(76) Inventors: Kam Kwong Allen Wong, Hong Kong (CN); Wai Ho Cheung, Hong Kong (CN)

(21) Appl. No.: 12/584,188

(22) Filed: Sep. 2, 2009

(51) Int. Cl. G04C 11/02; G04B 19/22; G04B 19/24

(52) U.S. Cl. 368/47; 368/21; 368/28

(57) ABSTRACT

The time and/or date display of a clock radio is settable remotely and automatically by a radio frequency information signal. The time and/or date display is initially set in manufacturing of the clock radio simultaneously to a plurality of clock radio units, and the display may also be adjusted with an adjusting radio frequency signal broadcast to a plurality of clock radio units simultaneously.

### BACKGROUND OF THE INVENTION

1. Field of the Invention

This invention relates to a method and system for setting and adjusting the time and/or date display of a clock radio automatically.

2. Background Art

A clock radio is a radio unit capable of receiving AM, FM, and/or SW radio signals through various broadcast frequency bands, and it is also provided with a time display or both time and date displays. The time and date displays of a clock radio are commonly set or adjusted with manually operated switch buttons on such clock radio to execute various functions in the clock radio's electronic timing circuit. The operation is often rather time consuming to carry out, particularly in the initial power on stage of the clock radio.

Attempt has been made to obviate the above problems by providing setting features in a clock radio. The correct time is broadcast in a designated carrier frequency signal such as through designated broadcast carrier channels WWVB, WWVV, WWVH in the United States or CHU in Canada in order the time and date display of the clock radio may be set accordingly. However, such features have presented a large problem in actual usage due to environmental reasons, such as weather condition, location of the clock radio, and the broadcast carrier signal strength, the setting operation through designated broadcast carrier is often unsatisfactory or inoperative. Moreover, additional electrical circuits and associated mechanical hardware must be incorporated in the radio circuitry for receiving the designated carrier broadcast signal. The necessary additional electrical components and mechanical hardware required for carrying the operation inherently would increase the cost of manufacture of the radio and consequentially rendering the selling price of the clock radio unnecessarily costly.

Another known system incorporates a permanent program and data memory in the clock in which the memory stores all the time and calendar data necessary to operate the clock to provide the correct time and date display. In such system, the memory of each clock must be initially set during manufacture with a data input equipment such as a computer by physically connecting the computer with each clock radio individually for entering the time and date data into the memory of each clock radio. This operation is labor intensive to carry out so that it increases the manufacturing time of the clock radio such that it is not conducive to a mass production process of the clock radio. Furthermore, it is difficult to change the data stored in the memory when it is necessary to vary the time and calendar data after the manufacturing of the clock radio.

### SUMMARY OF THE INVENTION

It is the principal object of the present invention to provide a system and method with which the setting and/or adjusting of the time and/or date display in a clock radio may be automatically carried out with the time and date data transmitted thereto by a signal input provided remotely with a signal transmission means.

It is another object of the present invention to provide a clock radio in which the time and/or date display is remotely settable automatically with an RF frequency signal transmitted to the clock radio by an RF transmitter through a radio carrier frequency band.

It is another object of the present invention to provide a clock radio in which the time and/or date display is remotely settable automatically with infrared (IR) frequency signal provided with an IR transmitter.

### BRIEF DESCRIPTION OF THE DRAWING

Other objects and advantages of the present invention will become apparent from the following detailed description of the preferred embodiment thereof in connection with the following accompanying drawings:

FIG. 1 is a schematic block diagram of the system of the present invention.

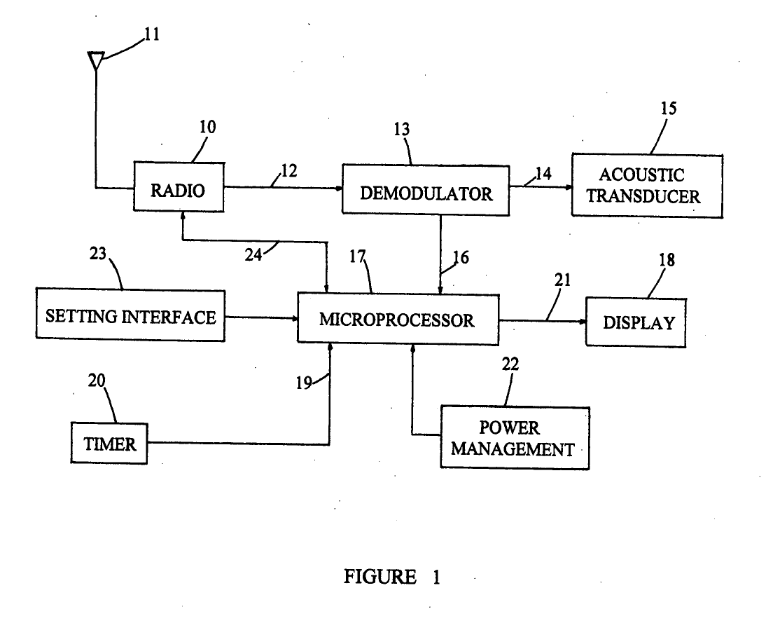

FIG. 2 is a schematic block diagram of a second embodiment of the present invention including an optical signal receiver for pre-setting the clock radio display.

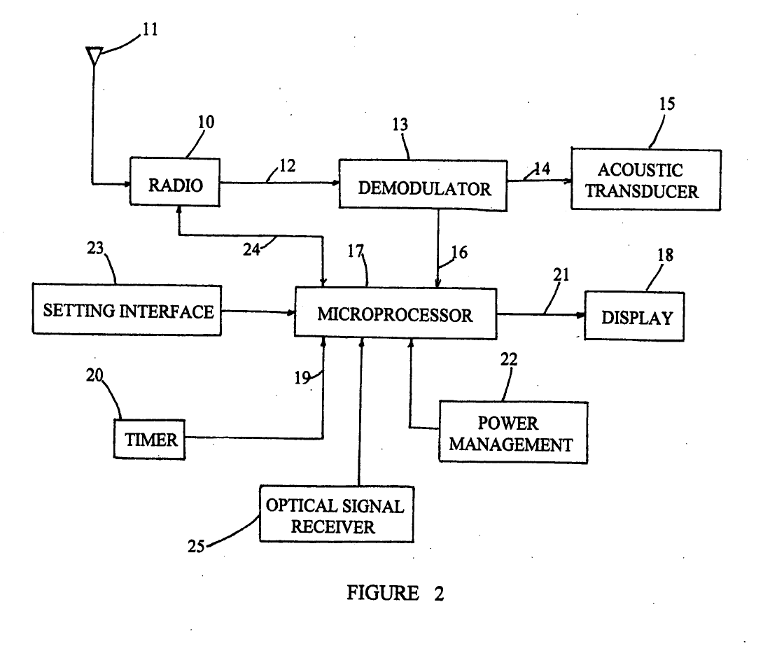

### DETAILED DESCRIPTION OF THE PREFERRED EMBODIMENT

The clock radio according to the present invention has a radio frequency (RF) receiver unit 10 that is operative to receive via an antenna 11 either a radio frequency signal from a specific transmitter or a radio broadcast signal from a radio station through an AM, LW, SW or FM carrier radio frequency band. In the exemplary embodiment, the radio signal 12 includes a digital signal containing the time and date information or an acoustic signal of the radio broadcast. The digital signal may be in the form of a predetermined protocol such as Morse coding containing the date and/or time data associated with a specific time zone or geographical region.

The radio receiver unit 10 forwards the composite radio broadcast signal 12 to a demodulator 13 which retrieves the acoustic signal 14 from the radio broadcast signal and forwards the acoustic signal 14 to an acoustic transducer 15 to produce the audio sound output of the radio broadcast. The acoustic transducer 15 is an electromechanical transducer such as a speaker capable of transforming the acoustic signal to the sound energy output.

In the meantime, the demodulator 13 retrieves and forwards the audio signal containing the digital signal data information 16 to a microprocessor 17 which further processes and stores the data of the current time and/or date of a selected time zone in its internal memory. The clock radio includes a display device 18 which may be in the form of a liquid crystal display (LCD), or a light emitting diode (LED) display, which operates to produce a digital display, or an LCA display which operates to show a pictorial display of an analog clock having long and short hands indicating the time and/or date. The microprocessor 17 receives a timing signal 19 from a reference timer 20 which may a crystal or similar device capable of generating the constant timing signal 19 for the display device 18. The display device 18 can exhibit a time and/or date display under the control of the microprocessor 17. The microprocessor 17 includes logic circuits, internal memory and operating software programs which are operative to analyze the digital signal component 16 to generate the data to be stored in the microprocessor's internal memory of the time and/or date for the region in which the clock radio is intended to be located. Therefore, the time and/or date display may be set or adjusted automatically without requiring mechanical operation to be carried out by the clock radio user especially when the clock radio is connected the first time to the power supply to initiate its operation.

The microprocessor 17 is initially operated with an internal battery 22 which serves as a power management device to operate the system and to maintain its time and/or date data. The radio receiver unit 10 is set to receive the broadcast signal at a particular selected broadcast carrier frequency band by operating a setting interface 23 to direct the microprocessor 17 to send a supervisory signal 24 to the radio receiver 10 for instructing the radio receiver 10 that the broadcast signal is to be received in the selected broadcast carrier frequency band.

During the manufacture of the clock radio, a specific radio transmitter is used to broadcast a predetermined protocol, such as Morse code, at the selected specific radio frequency signal carrier band containing the date and/or time data associated with a specific time zone or geographical region to the clock radio so that an initial time and/or date display is shown on the display device 18.

The reference timer 20 will provide the clock timing signal 19 to the microprocessor 17 as long as the latter is maintained operating by the internal battery 22. In order to save the power of the internal battery 22, the microprocessor 17 will initially function in a standby mode, and it is powered up only when the user turns on the clock radio for the first time. During manufacture, the initial time and/or date setting RF signal can be received simultaneously and remotely by a large number of the clock radios being produced without having to connect physically each unit separately to a setting computer as in the present known systems thus it reduces greatly the time required for the production of the clock radio, and it increases considerably the ease of manufacture and the operation of initially setting the time and/or date display of the clock radio. Furthermore, re-programming of the clock radio may be carried out with ease with a radio transmitter to send the changes to the time and/or date display through a broadcast signal remotely without having to enter the changes manually or to make changes to its component by disassembling the clock radio, and the same method may be used to re-adjust or to re-program the clock radio easily by a serviceperson in a service center with a specific RF transmitter.

In a second embodiment of the present invention, an additional optical signal receiver 25 is incorporated in the system. The optical signal receiver 25 is directly connected to the microprocessor 17. With this embodiment, the initial time and/or date of the displayed in the display device 18 may be alternatively set with an infrared transmitter sending the time and/or date data remotely to the microprocessor 17 directly during manufacture of the clock radio. Thereafter the clock radio may then be re-set or adjusted subsequently with the RF transmission as described above.

While the present invention has been shown and described in the preferred embodiments thereof, it will be apparent that various modifications can be made therein without departing from the spirit or essential attributes thereof, and it is desired therefore that only such limitations be placed thereon as are imposed by the appended claims.

What is claimed is:

1. A method of remotely setting a data display of a clock radio automatically comprising,
transmitting an information signal remotely to a radio frequency receiver of said clock radio through a carrier frequency,
demodulating said information signal to a data signal,
processing said data signal with a microprocessor having logic circuit, internal memory and signal generating means and operative to analyze said data signal to generate an initial data to be stored in said clock radio.

2. A method according to claim 1 wherein said carrier frequency is a radio carrier frequency band and said information signal is a time display data for a selected time zone and geographical region.

3. A method according to claim 1 wherein said carrier frequency is a radio carrier frequency band and said information signal is a time and date display data for a selected time zone and geographical region.

4. A method according to claim 3 wherein said information signal is transmitted remotely to said clock radio through a radio broadcast carrier frequency band, and said information signal is a composite signal including audio signal and time display data.

5. A method according to claim 4 including setting said microprocessor to instruct said radio frequency receiver to receive said display data from a selected radio frequency band.

6. A method according to claim 4 wherein said information signal is transmitted remotely to said microprocessor by an infrared frequency carrier.

7. A method according to claim 5 wherein said information signal is transmitted remotely to a plurality of clock radio simultaneously for setting said display.

8. A system for remotely setting a data display of a clock radio automatically comprising:
a radio frequency receiver operative to receive an information signal including display data to be exhibited by a display device of said clock radio,
a demodulator connected to said receiver and operative to demodulate said information signal from said receiver unit for generating a demodulated signal,
a microprocessor connected to said demodulator and operative for analyzing said demodulated signal to generate a display driver signal for operating said display device to exhibit automatically said display data by said display device of said clock radio.

9. A system according to claim 8 including a setting interface connected to said microprocessor and being operative to direct said microprocessor to instruct said radio frequency receiver to receive said information signal in a specific radio frequency carrier band.

10. A system according to claim 9 including a timer means connected to said microprocessor operative to provide a constant time signal to said microprocessor for generating said display driver signal.

11. A system according to claim 10 including an internal battery connected to said microprocessor and operative to maintain an initial display information for exhibiting in said display device.

12. A system according to claim 11 including an optical receiver connected to said microprocessor and operative for receiving said information signal remotely from an infrared transmitter for setting said initial display information in said display device.

13. A system according to claim 11 wherein said radio receiver is operative to receive a radio frequency signal including said information signal, and said demodulator is operative to demodulate said information signal to forward to said microprocessor for generating information data to be stored in said internal memory of said microprocessor according to a selected region wherein said clock radio is intended to be located.

14. A system according to claim 13 wherein said display device of a plurality of clock radios is adjustable with said information signal broadcast remotely to said plurality of clock radios through a specific radio frequency transmitter via a specific radio frequency carrier band.

15. A system according to claim 13 wherein said internal memory in said microprocessor of a plurality of clock radios is adjustable with said information signal broadcast remotely to said plurality of clock radios through a specific radio frequency transmitter via a specific radio frequency carrier band.
